(19) United States
(12) Patent Application Publication
(10) Pub. No.: US 2025/0001731 A1
(43) Pub. Date: Jan. 2, 2025

(54) Gypsum Panel Having Enhanced Gypsum Core to Facing Material Bond

(71) Applicant: Gold Bond Building Products, LLC, Charlotte, NC (US)

(72) Inventors: Eli Stav, Charlotte, NC (US); Ma-Ikay Miatudila, Monroe, NC (US); Brian Bland, Matthews, NC (US); Ratnasabapathy Gurunathan Iyer, Charlotte, NC (US); Robert Piercy, Mesa, AZ (US)

(21) Appl. No.: 18/758,381

(22) Filed: Jun. 28, 2024

Related U.S. Application Data
(60) Provisional application No. 63/511,250, filed on Jun. 30, 2023.
(60) Provisional application No. 63/594,980, filed on Nov. 1, 2023.

(51) Int. Cl. B32B 13/08; B32B 37/15; C04B 11/00; C04B 111/00

(52) U.S. Cl. CPC B32B 13/08; B32B 37/15; C04B 11/00; B32B 2250/40; B32B 2260/028; B32B 2260/04; B32B 2264/10; B32B 2264/303; B32B 2307/7246; B32B 2315/18; B32B 2317/125; B32B 2607/00; C04B 2111/0062

(57) ABSTRACT

The present invention is directed to a gypsum panel with an enhanced gypsum core to facing material bond and a method of making such gypsum panel. In one embodiment, the gypsum panel comprises a gypsum core, a first facing material, and a second facing material. The first facing material and/or the second facing material having a nucleating composition applied to a surface thereof. The methods of the present invention are directed to making the aforementioned gypsum panels by providing the first facing material, providing a gypsum slurry onto the first facing material, providing a second facing material on the gypsum slurry, and providing a nucleating composition on the first facing material before depositing the gypsum slurry onto the first facing material, on the gypsum slurry before providing the second facing material on the gypsum slurry, on the second facing material before providing the second facing material on the gypsum slurry, or a combination thereof.

### RELATED APPLICATIONS

The present application is based upon and claims priority to U.S. Provisional Patent Application Ser. No. 63/511,250, having a filing date of Jun. 30, 2023, and U.S. Provisional Patent Application Ser. No. 63/594,980, having a filing date of Nov. 1, 2023, both of which are incorporated herein by reference in their entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. The mixture is cast and allowed to set by reaction of the calcined gypsum with the water. Notably, the gypsum core to facing material bond is a significant consideration in the formation of a gypsum panel. Indeed, the gypsum core to facing material bond may affect the strength of a gypsum panel and/or the nail pull resistance of a gypsum panel.

As a result, there is a need to provide a gypsum panel having an enhanced gypsum core to facing material bond.

### SUMMARY OF THE INVENTION

Aspects and advantages of the invention will be set forth in part in the following description, or may be obvious from the description, or may be learned through practice of the invention.

In accordance with one embodiment of the present invention, a method of making a gypsum panel is disclosed. The method comprises: providing a first facing material; depositing a gypsum slurry comprising stucco and water onto the first facing material; providing a second facing material on the gypsum slurry; allowing the stucco to convert to calcium sulfate dihydrate; and wherein the method further comprises providing a nucleating composition comprising a nucleating agent on the first facing material before depositing the gypsum slurry onto the first facing material, on the gypsum slurry before providing the second facing material on the gypsum slurry, on the second facing material before providing the second facing material on the gypsum slurry, or a combination thereof.

In accordance with another embodiment of the present invention, a gypsum panel is disclosed. The gypsum panel comprises: a gypsum core, the gypsum core comprising gypsum; and a first facing material and a second facing material sandwiching the gypsum core, wherein a nucleating composition is applied to at least a portion of a surface of the first facing material, the second facing material, or both that is adjacent to the gypsum core, the nucleating composition penetrating at least a portion of a thickness of the first facing material, the second facing material, or both.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a gypsum core, one or more nucleating compositions, one or more nucleation sites, one or more facing materials, or a combination thereof. In one aspect, one or more nucleation sites may be formed by the application of a nucleating composition. The present inventors have discovered that the gypsum panel disclosed herein can have various benefits due to the use of a nucleating composition. For instance, the present inventors have discovered that the mechanical properties and characteristics of the gypsum panel may be improved. For instance, the gypsum panel disclosed herein may have increased nail pull resistance, increased panel strength, and/or enhanced bonding (e.g., wet bond, dry bond) between the gypsum core and one or more of the respective facing materials. Further, for instance, the gypsum panel disclosed herein may utilize less starch than a traditional gypsum panel. Notably, a reduction in starch may allow for a reduction in the heat and/or energy used to dry the gypsum panel. Additionally, the gypsum panel disclosed herein may have enhanced air and water barrier properties, such as enhanced water penetration resistance. Notably, the gypsum panel disclosed herein may be an air and water barrier (“AWB”) gypsum panel.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. It should be understood that any concentration values disclosed herein may refer to mass concentration, molar concentration, number concentration, or volume concentration. Notably, some aspects of the present invention may omit one or more of the features disclosed herein.

In general, the gypsum core may comprise calcium sulfate dihydrate. The gypsum used to make the gypsum core may be from a natural source, a synthetic source, and/or from reclaim and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In some aspects, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, a gypsum panel formed in accordance with the present disclosure may be formed from a method as disclosed herein. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material surface of the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

Generally, a gypsum panel formed in accordance with the present disclosure may have a nucleating composition applied to any component thereof (e.g., a facing material) at any time of the process disclosed herein, including during, before, and/or after any of the process steps disclosed herein. In general, a nucleating composition may be applied to one or more facing materials (e.g., first facing material, second facing material). Generally, the method of application of the nucleating composition is not limited by the present disclosure and may include any method of application known in the art. Notably, the nucleating composition may be applied to the first facing material, the gypsum slurry, the second facing material, or a combination thereof. In some aspects, a nucleating composition may be applied by spraying, brushing, curtain coating, and/or roll coating. The application of a nucleating composition may form one or more nucleation sites on a gypsum panel component to which the nucleating composition is applied (e.g., first facing material, second facing material). In one aspect, a nucleating composition may be applied to at least a portion of a surface of a first facing material and/or at least a portion of a surface of a second facing material that is adjacent to the gypsum slurry and/or gypsum core (i.e., the gypsum slurry and/or gypsum core facing surface of the first facing material, the gypsum slurry and/or gypsum core facing surface of the second facing material) before the gypsum slurry is deposited, provided, or contacted with the first facing material and/or before the second facing material is provided on or contacted with the gypsum slurry respectively. Further, in another aspect, a nucleating composition may be applied to the gypsum slurry before the second facing material is provided on or contacted with the gypsum slurry. In this respect, the nucleating composition may be applied to at least a portion of the gypsum slurry adjacent the second facing material before the second facing material is provided on or contacted with the gypsum slurry. Additionally, in yet another aspect, the nucleating composition may be applied to the gypsum slurry before the second facing material is provided on or contacted with the gypsum slurry and may be applied to at least a portion of the surface of the second facing material that is adjacent the gypsum slurry (i.e., the gypsum slurry facing surface of the second facing material) before the second facing material is provided on or contacted with the gypsum slurry.

As previously disclosed herein, the nucleating composition may be applied to one or more facing materials on a surface or side of a facing material (e.g., first facing material, second facing material) adjacent to a gypsum slurry and/or gypsum core. In general, the nucleating composition may be applied to one or more facing materials on a surface or side of a facing material (e.g., first facing material, second facing material) opposite a gypsum slurry and/or gypsum core. In this respect, the nucleating composition may be applied to one or more facing materials on the outward facing surface of one or more facing materials.

In general, a nucleating composition may be applied to one or more facing materials (e.g., first facing material, second facing material) during the manufacturing process of the gypsum panel and/or in an offline process. When incorporated and/or applied in an offline process, a nucleating composition may be applied to a facing material (e.g., first facing material, second facing material) before the facing material is utilized in the manufacturing process of the gypsum panel.

Generally, a nucleating composition and/or any of the components of a nucleating composition (e.g., a nucleating agent, a grinding agent) may be present between the first facing material and the gypsum slurry and/or gypsum core and/or may be present between the second facing material and the gypsum slurry and/or gypsum core.

In general, a nucleating composition may comprise one or more nucleating agents, one or more grinding agents, a liquid, or a combination thereof. For instance, the one or more nucleating agents may include gypsum (i.e., calcium sulfate dihydrate), stucco, water, potash, one or more dispersants, one or more surfactants, or a combination thereof. Generally, in one aspect, a nucleating composition may comprise one or more grinding agents. The one or more grinding agents may assist in decreasing the particle size of a nucleating composition and/or any components (e.g., a nucleating agent) thereof. In one aspect, the one or more grinding agents may include dextrose, a sulfonate (e.g., a lignosulfonate, a naphthalene sulfonate), a carboxylate (e.g., a polycarboxylate ester), boric acid, sodium trimetaphosphate, a starch, or a combination thereof. Further, in one aspect, a nucleating composition may comprise a liquid (e.g., one or more surfactants, one or more dispersants, one or more siloxanes, one or more retarders, one or more alcohols, and/or water). Additionally, in one aspect, the nucleating composition may include an accelerator, such as one or more of the accelerators described in U.S. Pat. No. 9,878,950, which is incorporated herein by reference in its entirety. Notably, in one aspect, a nucleating composition may comprise urea.

In general, a facing material may comprise a nucleating composition and/or any components (e.g., a nucleating agent, a grinding agent) thereof. In some aspects, a facing material may comprise one or more nucleation sites. The one or more nucleation sites may comprise and/or be formed by one or more nucleating agents of a nucleating composition. The one or more nucleation sites may be present on a surface of a facing material and/or within a facing material (e.g., first facing material, second facing material). For instance, one or more nucleation sites may be present on the surface of a first facing material adjacent to a gypsum core and/or gypsum slurry. Further, for instance, one or more nucleation sites may be present on the surface of a second facing material adjacent to a gypsum core and/or gypsum slurry. The one or more nucleation sites may enhance the bond between one or more facing materials and the gypsum core.

Notably, a gypsum panel formed in accordance with the present disclosure may comprise more than one nucleating agent. For instance, a gypsum panel disclosed herein may comprise two nucleating agents or three nucleating agents. The nucleating agents may be selectively chosen to form a combination of nucleating agents that synergistically interact to enhance the bond between one or more facing materials and the gypsum core.

Generally, a nucleating composition and/or any components (e.g., a nucleating agent, a grinding agent) thereof may be in the form of a solid (e.g., powder, fines, granules), a liquid, or a mixture thereof. In general, a nucleating composition may be applied to any component of a gypsum panel in the form of a solid, a liquid (e.g., a solution), or a mixture (e.g., a dispersion) thereof. As used herein, the term “dispersion” refers to a liquid having solid particles dispersed therein. In one aspect, the liquid of a dispersion may be water and the solid particles of the dispersion may be one or more nucleating agents (e.g., gypsum) and/or one or more grinding agents. In general, the nucleating composition may be applied as a dry application, a wet application, or a combination thereof. As used herein, a “dry application” of a nucleating composition refers to the application of a nucleating composition that does not comprise a liquid. As used herein, a “wet application” of a nucleating composition refers to the application of a nucleating composition that comprises a liquid. For instance, if a nucleating composition that comprises water is applied to a first facing material and/or a second facing material, the nucleating composition is applied via a wet application.

Notably, the components of the nucleating composition (e.g., a nucleating agent, a grinding agent) may be combined by any method known in the art or disclosed herein. For instance, the components of a nucleating composition may be mixed or combined as is or may be ground or milled together, such as by dry milling or wet milling. As used herein, “milled” is synonymous with “ground”. The milling of a nucleating composition and/or any components (e.g., a nucleating agent, a grinding agent) thereof may decrease the average particle size of the nucleating composition and/or any components (e.g., a nucleating agent, a grinding agent) thereof. In one aspect, a nucleating composition and/or any components (e.g., a nucleating agent, a grinding agent) thereof may be ball-milled. In this respect, in one aspect, a nucleating agent such as stucco and/or gypsum may be ball-milled to form at least one component of a nucleating composition. The ball-milling of a nucleating composition and/or any components (e.g., a nucleating agent, a grinding agent) thereof may be particularly advantageous. In this respect, the application of a ball-milled nucleating composition and/or the application of a nucleating composition comprising ball-milled components (e.g., a nucleating agent, a grinding agent) may enhance the gypsum core to facing material bond as compared to a nucleating composition that is not ball-milled and/or a nucleating composition that does not contain ball-milled components.

As previously disclosed, a nucleating composition and/or any components thereof may be ball-milled. However, it should be understood that a nucleating composition and/or any components thereof may be milled or ground by other equipment such as, for instance, an attritor, a vibration mill, an impact mill, a planetary ball mill, a jet mill, and the like.

Generally, a nucleating composition and/or any components thereof may undergo mixing in a shear mixer, such as a Quadro® Liquids high shear mixer, pin mixer, or an Axiflow® high shear mixer, at any time of the process disclosed herein, including at, before, and/or after any of the process steps disclosed herein. In general, a shear mixer may combine a liquid (e.g., one or more surfactants, one or more dispersants, one or more siloxanes, one or more retarders, one or more alcohols, and/or water) with a nucleating composition and/or any components (e.g., a nucleating agent, a grinding agent) thereof. In one aspect, the combination of a liquid and a nucleating composition and/or any components thereof in a shear mixer may form a dispersion. In this respect, in one aspect, the nucleating composition and/or any components thereof may form the solid portion of a dispersion. In some aspects, a nucleating composition and/or any components thereof may be mixed or combined prior to being mixed in a shear mixer. In this respect, in one aspect, a nucleating composition and/or any components thereof may undergo one or more mixing processes. Notably, a shear mixer may continuously mix a liquid with a nucleating composition and/or any components thereof. After the shear mixer has mixed a liquid with a nucleating composition and/or any components thereof, the resulting nucleating composition, which may be in the form of a dispersion, may be applied (e.g., sprayed) to a facing material and/or a gypsum slurry.

Generally, a surface of a facing material (e.g., first facing material, second facing material) adjacent to a gypsum slurry and/or gypsum core may include a nucleating composition and/or any components (e.g., a nucleating agent, a grinding agent) thereof applied to and/or present on at least a portion of the surface of the facing material adjacent to a gypsum slurry and/or gypsum core. For instance, a nucleating composition and/or any components (e.g., a nucleating agent, a grinding agent) thereof may be applied to and/or be present on the surface of a facing material adjacent to a gypsum slurry and/or gypsum core in an amount of about 1% or more of the surface area of the surface of the facing material, such as in an amount of about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the surface of the facing material.

As previously disclosed herein, the application of a nucleating composition to one or more facing materials may result in the formation of one or more nucleation sites on and/or in one or more facing materials. In this respect, one or more nucleating agents of a nucleating composition may form one or more nucleation sites on and/or in one or more facing materials. The one or more nucleation sites may accelerate the conversion of stucco and water into gypsum (i.e., calcium sulfate dihydrate). In this respect, the one or more nucleation sites may accelerate gypsum crystal formation at the interface of one or more facing materials and a gypsum slurry. In general, after a nucleating composition is applied to a facing material and a gypsum slurry is deposited on and/or contacted with the facing material, the presence of the one or more nucleation sites may enhance the gypsum core to facing material bond.

In one aspect, when a nucleating composition comprises gypsum as a nucleating agent, the gypsum crystals of the gypsum may form one or more nucleation sites. The gypsum crystals may have various shapes and/or sizes. For instance, one or more gypsum crystals may be needle-shaped (e.g., acicular), tabular, bladed, or a combination thereof.

In one aspect, one or more nucleation sites may be present on the surface of a facing material adjacent to a gypsum slurry and/or gypsum core in an amount of about 1% or more of the surface area of the surface of the facing material, such as in an amount of about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the surface of the facing material.

As previously disclosed herein, a nucleating composition may be applied to one or more facing materials. In one aspect, a nucleating composition may be applied to one or more plies of a facing material. In one aspect, the first facing material and/or the second facing material may include a top ply and a bottom ply. As used herein, the “top ply” refers to the ply of the facing material that is furthest from the gypsum slurry and/or gypsum core. As used herein, the “bottom ply” refers to the ply of the facing material that is closest to and/or adjacent to the gypsum slurry and/or gypsum core. In one aspect, the bottom ply may be penetrated by a nucleating composition and/or any components thereof. It should be understood that if a facing material includes plies that are located between the top ply and the bottom ply, the bottom ply may be referred to as the first ply with the plies being numbered in ascending order. For instance, if a facing material consists of three plies, the bottom ply may be referred to as the first ply, the second ply may be referred to as the second ply, and the top ply may be referred to as the third ply.

In general, a facing material, such as a paper facing material, may include 1 to 8 plies. For instance, a facing material may include 1 ply or more, such as 2 plies or more, such as 3 plies or more, such as 4 plies or more, such as 5 plies or more, such as 6 plies or more, such as 7 plies or more, such as 8 plies or less, such as 7 plies or less, such as 6 plies or less, such as 5 plies or less, such as 4 plies or less, such as 3 plies or less, such as 2 plies or less. In one aspect, one or more plies of a facing material may comprise paper.

In one aspect, the application of a nucleating composition may result in the penetration and/or embedment of a nucleating composition and/or any components (e.g., a nucleating agent, a grinding agent) thereof in one or more of the facing materials (e.g., first facing material, second facing material), which may enhance the gypsum core to facing material bond. Notably, the penetration and/or embedment of a nucleating composition and/or any components (e.g., a nucleating agent, a grinding agent) thereof may result in increased gypsum crystal formation in the facing material, such as increased gypsum crystal formation in one or more plies of a facing material. In one aspect, the application of a nucleating composition may result in the penetration and/or embedment of the nucleating composition and/or any components thereof in one or more plies of a facing material, such as the embedment or penetration of at least a portion of the thickness of the bottom ply of a facing material. Notably, the depth of penetration of the nucleating composition and/or any components (e.g., a nucleating agent, a grinding agent) thereof may be affected by the bottom cobb of the facing material, the concentration of the nucleating agent in the nucleating composition, the surface tension of the nucleating composition, and/or the paper tension of the facing material. In one aspect, for instance, the bottom cobb of the facing material may be increased, which may allow for further penetration and/or embedment of the nucleating composition and/or any components thereof in a facing material. Further, if the nucleating composition is applied via spraying, the intensity and/or angle of the spraying and the distance of the spraying mechanism to the facing material may affect the depth of penetration of the nucleating composition and/or any components (e.g., a nucleating agent, a grinding agent) thereof. Further, the application of a nucleating composition comprising a liquid (e.g., water) may increase the swelling of the facing material and/or increase the porosity of the facing material, which may enhance the facing material to gypsum core bond. In this respect, an increase in the swelling and/or porosity of a facing material may allow the nucleating composition and/or any components thereof to penetrate deeper into the facing material, which may result in enhanced gypsum crystal growth deeper in the facing material.

Generally, a nucleating composition and/or any components thereof may penetrate or be present in at least a portion of the thickness of a respective facing material (e.g., first facing material, second facing material). In this respect, one or more nucleation sites formed by the application of the nucleating composition may be present at a selectively chosen depth of the thickness of a respective facing material. In one aspect, the nucleating composition and/or any components (e.g., a nucleating agent, a grinding agent) thereof may penetrate or be present in a respective facing material (e.g., first facing material, second facing material) by about 0% to about 100% of the thickness of the respective facing material, such as about 0% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less.

In one aspect, the nucleating composition and/or any components thereof may penetrate one or more plies of a respective facing material (e.g., first facing material, second facing material). In this respect, one or more nucleation sites formed by the application of a nucleating composition may be present on and/or within a selectively chosen number of plies of a respective facing material. For instance, a nucleating composition and/or any components (e.g., a nucleating agent, a grinding agent) thereof may penetrate 1 ply or more, such as 2 plies or more, such as 3 plies or more, such as 4 plies or more, such as 5 plies or more, such as 6 plies or more, such as 7 plies or more of a facing material. In general, a nucleating composition and/or any components (e.g., a nucleating agent, a grinding agent) thereof may penetrate 8 plies or less, such as 7 plies or less, such as 6 plies or less, such as 5 plies or less, such as 4 plies or less, such as 3 plies or less, such as 2 plies or less of a facing material. Furthermore, the aforementioned values may refer to the number of plies that one or more nucleation sites are present in a respective facing material.

Generally, the longer the nucleating composition and/or any component thereof (e.g., nucleating agent) is in contact with a facing material and/or one or more plies of a facing material, the deeper the penetration of the nucleating composition and/or any component thereof. Notably, a nucleating composition and/or any components thereof may be in contact with a facing material and/or one or more plies of a facing material for a period of about 1 second to about 30 seconds, including all increments of 1 second therebetween. For instance, a nucleating composition and/or any components thereof may be in contact with a facing material and/or one or more plies of a facing material for about 1 second or more, such as about 5 seconds or more, such as about 10 seconds or more, such as about 15 seconds or more, such as about 20 seconds or more, such as about 25 seconds or more, such as about 30 seconds or less, such as about 25 seconds or less, such as about 20 seconds or less, such as about 15 seconds or less, such as about 10 seconds or less, such as about 5 seconds or less. In this respect, a nucleating composition and/or any components thereof may be in contact with a facing material and/or one or more plies of a facing material for a period of about 1 second to about 30 seconds, including all increments of 1 second therebetween, until a gypsum slurry contacts or is provided on a respective facing material.

In one aspect, a facing material and/or one or more plies (e.g., top ply, bottom ply) of a respective facing material (e.g., first facing material, second facing material) may have a cobb (e.g., bottom cobb) of from about 30 g/m² to about 150 g/m², including all increments of 0.01 g/m² therebetween, as tested according to TAPPI T 441. For instance, one or more plies (e.g., bottom ply) of a respective facing material may have a cobb of about 30 g/m² or more, such as about 40 g/m² or more, such as about 50 g/m² or more, such as about 60 g/m² or more, such as about 70 g/m² or more, such as about 80 g/m² or more, such as about 90 g/m² or more, such as about 100 g/m² or more, such as about 110 g/m² or more, such as about 120 g/m² or more, such as about 130 g/m² or more, such as about 140 g/m² or more. In general, one or more plies (e.g., bottom ply) of a respective facing material may have a cobb of about 150 g/m² or less, such as about 140 g/m² or less, such as about 130 g/m² or less, such as about 120 g/m² or less, such as about 110 g/m² or less, such as about 100 g/m² or less, such as about 90 g/m² or less, such as about 80 g/m² or less, such as about 70 g/m² or less, such as about 60 g/m² or less, such as about 50 g/m² or less, such as about 40 g/m² or less. In general, as the cobb value of a ply decreases, the absorption of the ply also decreases.

The nucleating composition may be applied to and/or present in a gypsum panel in an amount of 0.001 lbs/MSF to 5 lbs/MSF, including all increments of 0.001 lbs/MSF therebetween. For instance, the nucleating composition may be applied to and/or present in a gypsum panel in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.3 lbs/MSF or more, such as 0.4 lbs/MSF or more, such as 0.5 lbs/MSF or more, such as 0.6 lbs/MSF or more, such as 0.7 lbs/MSF or more, such as 0.8 lbs/MSF or more, such as 0.9 lbs/MSF or more, such as 1 lb/MSF or more, such as 1.1 lbs/MSF or more, such as 1.2 lbs/MSF or more, such as 1.3 lbs/MSF or more, such as 1.4 lbs/MSF or more, such as 1.5 lbs/MSF or more, such as 1.6 lbs/MSF or more, such as 1.7 lbs/MSF or more, such as 1.8 lbs/MSF or more, such as 1.9 lbs/MSF or more, such as 2 lbs/MSF or more, such as 2.5 lbs/MSF or more, such as 3 lbs/MSF or more, such as 4 lbs/MSF or more. In general, the nucleating composition may be applied to and/or present in a gypsum panel in an amount of 5 lbs/MSF or less, such as 4 lbs/MSF or less, such as 3 lbs/MSF or less, such as 2.5 lbs/MSF or less, such as 2 lbs/MSF or less, such as 1.9 lbs/MSF or less, such as 1.8 lbs/MSF or less, such as 1.7 lbs/MSF or less, such as 1.6 lbs/MSF or less, such as 1.5 lbs/MSF or less, such as 1.4 lbs/MSF or less, such as 1.3 lbs/MSF or less, such as 1.2 lbs/MSF or less, such as 1.1 lbs/MSF or less, such as 1 lb/MSF or less, such as 0.9 lbs/MSF or less, such as 0.8 lbs/MSF or less, such as 0.7 lbs/MSF or less, such as 0.6 lbs/MSF or less, such as 0.5 lbs/MSF or less, such as 0.4 lbs/MSF or less, such as 0.3 lbs/MSF or less, such as 0.2 lbs/MSF or less, such as 0.1 lbs/MSF or less. It should be understood that, as used herein, “lbs/MSF” means pounds per thousand square feet of gypsum panel.

Further, in some aspects, a nucleating composition may be applied to and/or present in a gypsum panel and/or any component (e.g., a facing material) thereof in an amount of 0.00001 wt. % or more, such as 0.00005 wt. % or more, such as 0.0001 wt. % or more, such as 0.0005 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more. In general, a nucleating composition may be applied to and/or present in a gypsum panel and/or any component (e.g., a facing material) thereof in an amount of 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less, such as 0.05 wt. % or less, such as 0.02 wt. % or less, such as 0.01 wt. % or less, such as 0.001 wt. % or less, such as 0.0005 wt. % or less, such as 0.0001 wt. % or less, such as 0.00005 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As previously disclosed, a nucleating composition may comprise a nucleating agent (e.g., gypsum). For instance, a nucleating agent (e.g., gypsum) may be present in a nucleating composition in an amount from about 0.01 wt. % to about 100 wt. %, including all increments of 0.01 wt. % therebetween. In this respect, a nucleating agent may be present in a nucleating composition in an amount of about 0.01 wt. % or more, such as about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 60 wt. % or more, such as about 70 wt. % or more, such as about 80 wt. % or more, such as about 90 wt. % or more, such as about 100 wt. % or less, such as about 90 wt. % or less, such as about 80 wt. % or less, such as about 70 wt. % or less, such as about 60 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less, such as about 5 wt. % or less, such as about 1 wt. % or less. Particularly, in one aspect, when a nucleating composition is applied via a wet application, a nucleating agent may be present in a nucleating composition in an amount from about 0.01 wt. % to about 50 wt. %, including all increments of 0.01 wt. % therebetween.

As previously disclosed herein, one or more grinding agents may be included in a nucleating composition. For instance, from about 0 wt. % to about 60 wt. %, including all increments of 0.01 wt. % therebetween, of one or more grinding agents may be included in a nucleating composition. In one aspect, a nucleating composition may comprise one or more grinding agents in an amount of about 0 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 4.5 wt. % or more, such as about 5 wt. % or more, such as about 5.5 wt. % or more, such as about 6 wt. % or more, such as about 6.5 wt. % or more, such as about 7 wt. % or more, such as about 8 wt. % or more, such as about 9 wt. % or more, such as about 10 wt. % or more, such as about 11 wt. % or more, such as about 12 wt. % or more, such as about 13 wt. % or more, such as about 14 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more. In general, a nucleating composition may comprise one or more grinding agents in an amount of about 60 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 14 wt. % or less, such as about 13 wt. % or less, such as about 12 wt. % or less, such as about 11 wt. % or less, such as about 10 wt. % or less, such as about 9 wt. % or less, such as about 8 wt. % or less, such as about 7.5 wt. % or less, such as about 7 wt. % or less, such as about 6.5 wt. % or less, such as about 6 wt. % or less, such as about 5.5 wt. % or less, such as about 5 wt. % or less, such as about 4.5 wt. % or less, such as about 4 wt. % or less, such as about 3.5 wt. % or less, such as about 3 wt. % or less, such as about 2.5 wt. % or less, such as about 2 wt. % or less, such as about 1.5 wt. % or less, such as about 1 wt. % or less.

As previously disclosed, a nucleating composition may comprise a liquid (e.g., one or more surfactants, one or more dispersants, one or more siloxanes, one or more retarders, one or more alcohols, and/or water). For instance, a liquid may be present in a nucleating composition in an amount from about 0 wt. % to about 99.99 wt. %, including all increments of 0.01 wt. % therebetween. In this respect, a liquid (e.g., one or more surfactants, one or more dispersants, one or more siloxanes, one or more retarders, one or more alcohols, and/or water) may be present in a nucleating composition in an amount of about 0 wt. % or more, such as about 10 wt. % or more, such as about 20 wt. % or more, such as about 30 wt. % or more, such as about 40 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more. In general, a liquid (e.g., one or more surfactants, one or more dispersants, one or more siloxanes, one or more retarders, one or more alcohols, and/or water) may be present in a nucleating composition in an amount of about 99.99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 40 wt. % or less, such as about 30 wt. % or less, such as about 20 wt. % or less, such as about 10 wt. % or less. Particularly, in one aspect, when a nucleating composition is applied via a wet application, a liquid may be present in a nucleating composition in an amount from about 50 wt. % to about 99.99 wt. %, including all increments of 0.01 wt. % therebetween.

Generally, a nucleating composition and/or any components (e.g., a nucleating agent, a grinding agent) thereof may be ground or milled (e.g., ball milled) such that the nucleating composition and/or any components thereof have a particular average particle size. Notably, a nucleating composition and/or any components thereof may be milled at any time of the process disclosed herein, including during, before, and/or after any of the process steps disclosed herein. In one aspect, a nucleating composition may comprise gypsum that has a smaller average particle size than the gypsum of the gypsum core. Notably, a decrease in the average particle size of a nucleating composition and/or any components (e.g., a nucleating agent) thereof may enhance the gypsum core to facing material bond. In this respect, a decrease in the average particle size of a nucleating composition and/or any components (e.g., gypsum) thereof may increase the surface area on which gypsum crystals of the gypsum slurry may form. Such formation of gypsum crystals may enhance the gypsum core to facing material bond. Notably, the average particle size of the nucleating agent may be particularly influential. As previously discussed herein, a decrease in the average particle size of a nucleating agent may enhance the gypsum core to facing material bond. However, if the average particle size of the nucleating agent is too low, the particles of the nucleating agent may agglomerate, which may negatively affect the gypsum core to facing material bond.

In order to provide the desired effect, the nucleating composition and/or any component (e.g., a nucleating agent, a grinding agent) thereof may have a selectively chosen average particle size. For instance, the nucleating composition and/or any component (e.g., a nucleating agent, a grinding agent) thereof may have an average particle size of 5 mm or less, such as 4.5 mm or less, such as 4 mm or less, such as 3.5 mm or less, such as 3 mm or less, such as 2.5 mm or less, such as 2 mm or less, such as 1.5 mm or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 20 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The nucleating composition and/or any component (e.g., a nucleating agent, a grinding agent) thereof may have an average particle size of 1 nanometer or more, such as 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 25 microns or more, such as 40 microns or more, such as 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more, such as 1.5 mm or more, such as 2 mm or more, such as 2.5 mm or more, such as 3 mm or more, such as 3.5 mm or more, such as 4 mm or more, such as 4.5 mm or more. Furthermore, in one aspect, the aforementioned values may refer to a median particle size of the nucleating composition and/or any components thereof. In this respect, the nucleating composition and/or any components thereof may have a D10, D50, or D90 of any of the values previously disclosed, including any incremental values therebetween. Notably, in one aspect, the aforementioned values may refer to the agglomerate size of the nucleating composition and/or any components thereof. In one aspect, the aforementioned values may refer to the agglomerate size and the particle size of the nucleating composition and/or any components thereof. In this respect, the aforementioned values may refer to the combined average and/or combined median size of the agglomerates (i.e., particle agglomerates) and the individual particles of the nucleating composition and/or any components thereof. For instance, if a nucleating composition contains 30 wt. % agglomerates and 70 wt. % individual particles, all of the sizes of the agglomerates and the individual particles may be analyzed to determine an average and/or median of the combined agglomerates and individual particles.

Generally, the nucleating composition and/or any components thereof may have a selectively chosen particle size distribution. The particle size distribution of the nucleating composition and/or any components thereof may be monomodal, bi-modal, or multi-modal. The one or more modes may fall within any of the particle size values, including any ranges thereof, disclosed herein. In one aspect, from about 1% to about 35% of the particles of the nucleating composition and/or any components (e.g., a nucleating agent, a grinding agent) thereof may have a particle size smaller than 5.5 microns. The aforementioned percentage values may be based on volume percent and/or weight percent. For instance, a nucleating composition and/or any components (e.g., a nucleating agent, a grinding agent) thereof may have a particle size distribution such that about 1% or more, such as about 5% or more, such as about 10% or more, such as about 15% or more, such as about 20% or more, such as about 25% or more, such as about 30% or more of the particles of the nucleating composition and/or any components (e.g., a nucleating agent, a grinding agent) thereof have a particle size less than 5.5 microns. In general, a nucleating composition and/or any components (e.g., a nucleating agent, a grinding agent) thereof may have a particle size distribution such that about 35% or less, such as about 30% or less, such as about 25% or less, such as about 20% or less, such as about 15% or less, such as about 10% or less, such as about 5% or less of the particles of the nucleating composition and/or any components (e.g., a nucleating agent, a grinding agent) thereof have a particle size less than 5.5 microns. As previously disclosed herein, the aforementioned percentage values may be based on volume percent and/or weight percent.

In general, the nucleating composition and/or any component thereof (e.g., a nucleating agent) may have a specific surface area from about 0.25 m²/g to about 15 m²/g, including all increments of 0.01 m²/g therebetween. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the nucleating composition and/or any component thereof may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

It should be understood that a nucleating agent and/or a grinding agent of the nucleating composition may be calcined, partially calcined, or uncalcined.

In some aspects, a nucleating composition may include a phosphorus containing compound. For instance, in one aspect, the nucleating composition may include sodium monofluorophosphate.

The phosphorus containing compound may be a phosphite, a phosphate having the formula P(O)ₙ(X)ₘ wherein n is from 0 to 4, m is from 0 to 6, the sum of n and m is from 3 to 6, and X is hydrogen, halogen, sulfur, or selenium, a salt thereof, or a mixture thereof. In one embodiment, the phosphorus containing compound comprises a phosphite or a salt thereof. In another embodiment, the phosphorus containing compound comprises a phosphate having the formula P(O)ₙ(X)ₘ wherein n is from 0 to 4, m is from 0 to 6, the sum of n and m is from 3 to 6, and X is hydrogen, halogen, sulfur, or selenium, or a salt thereof. In a further embodiment, the phosphorus containing compound comprises a combination of a phosphite or a salt thereof and a phosphate having the formula P(O)ₙ(X)ₘ wherein n is from 0 to 4, m is from 0 to 6, the sum of n and m is from 3 to 6, and X is hydrogen, halogen, sulfur, or selenium, or a salt thereof.

As indicated above, the phosphorus containing compound may be a phosphate having the formula P(O)ₙ(X)ₘ wherein n is from 0 to 4, m is from 0 to 6, the sum of n and m is from 3 to 6, and X is hydrogen, halogen, sulfur, or selenium, or a salt thereof. In this regard X may be hydrogen, halogen, or sulfur. For instance, X may be halogen or sulfur. In one embodiment, X may be sulfur. In a further embodiment, X may be selenium. In another embodiment, X may be hydrogen. In another embodiment, X may be halogen. For instance, the halogen may be fluorine (or fluoro), chlorine (or chloro), bromine (or bromo), iodine (or iodo), or any combination thereof. For instance, in one embodiment, the halogen may be fluorine (or fluoro). It should be noted that when m is greater than 1, each X may be independent of another X. That is, each X may be identical or alternatively, one X may be different from another X.

In addition, as indicated above, n is from 0 to 4, such as from 1 to 4, such as from 2 to 4, such as from 2 to 3. Thus, n may be at least 0, such as at least 1, such as at least 2, such as at least 3 to 4 or less, such as 3 or less, such as 2 or less, such as 1 or less. Thus, n may be 0. Further, n may be 1. In another embodiment, n may be 2. In a further embodiment, n may be 3. In another further embodiment, n may be 4.

Also, as indicated above, m is from 0 to 6, such as from 1 to 6, such as from 1 to 5, such as from 1 to 4, such as from 1 to 3, such as from 1 to 2 or 2 to 3. Thus, m may be at least 0, such as at least 1, such as at least 2, such as at least 3, such as at least 4, such as at least 5 to 6 or less, such as 5 or less, such as 4 or less, such as 3 or less, such as 2 or less, such as 1 or less. In this regard, m may be 1. In another embodiment, m may be 2. In a further embodiment, m may be 3. In another further embodiment, m may be 4. In one embodiment, m may be 5. Finally, in a further embodiment, m may be 6.

In addition, as indicated above, the sum of n and m may be from 3 to 6. In this regard, the sum of n and m may be at least 3, such as at least 4, such as at least 5 to 6 or less, such as 5 or less, such as 4 or less. In one embodiment, the sum of n and m may be 3. In another embodiment, the sum of n and m may be 4. In a further embodiment, the sum of n and m may be 5. In another further embodiment, the sum of n and m may be 6.

In one particular embodiment, X may be halogen, such as fluorine (fluoro), n may be 3, and m may be 1. In another particular embodiment, X may be halogen, such as fluorine (fluoro), n may be 2, and m may be 2. In this regard, when X is halogen, the phosphorus containing compound may be referred to as a halophosphate.

When the phosphorus containing compound comprises a halophosphate, the halo may be any halogen atom suitable for the present invention. In this regard, the halogen may be fluorine (or fluoro), chlorine (or chloro), bromine (or bromo), iodine (or iodo), or any combination thereof. For instance, in one embodiment, the halogen may be fluorine (or fluoro) such that the halophosphate is a fluorophosphate. In another embodiment, the halogen may be chlorine (or chloro) such that the halophosphate is a chlorophosphate.

Further, the halophosphate may comprise any number of halogen atoms. For instance, the halophosphate may include at least 1 halogen atom, such as at least 2 halogen atoms, such as at least 3 halogen atoms, such as at least 4 halogen atoms, such as at least 5 halogen atoms, such as at least 6 halogen atoms. In this regard, the halophosphate may be a monohalophosphate, a dihalophosphate, a trihalophosphate, a tetrahalophosphate, a pentahalophosphate, a hexahalophosphate, or any mixture thereof. In one embodiment, the halophosphate includes a monohalophosphate. In another embodiment, the halophosphate includes a dihalophosphate.

As indicated above, the halogen may be fluorine. In this regard, the halophosphate may be a fluorophosphate. In particular, the fluorophosphate may be a monofluorophosphate, a difluorophosphate, a trifluorophosphate, a tetrafluorophosphate, a pentafluorophosphate, a hexafluorophosphate, or any mixture thereof. In one embodiment, the fluorophosphate may include a monofluorophosphate. In another embodiment, the fluorophosphate may include a difluorophosphate.

As also indicated above, X may be a hydrogen. In this regard, m may be 1. In one embodiment, m may be 2 such that the phosphate is a dihydrogen phosphate. In a particular embodiment, the compound may be a bis(dihydrogen phosphate). In another particular embodiment, the compound may be a tris(dihydrogen phosphate).

As indicated above, the phosphorus containing compound may be a phosphite. For instance, the phosphite may be an anion having the general formula [HPO₃]²⁻. In this regard, the phosphite may be a salt of phosphorus acid. In one embodiment, the phosphite may have the formula of the aforementioned phosphate wherein X is H. The remaining parameters of such formula may be the same as defined above and herein with respect to the phosphate. For instance, in the above formula, n may be 3 and m may be 1.

Furthermore, the phosphorus containing compound may be a salt. In this regard, the phosphorus containing compound may include ammonium, a metal, or a combination thereof. In one embodiment, the phosphorus containing compound includes ammonium. In another embodiment, the phosphorus containing compound includes a metal.

When the phosphorus containing compound includes a metal, the metal may be any metal employed in the art. For instance, the metal may be an alkali metal, an alkaline earth metal, a transition metal, or a combination thereof. In one embodiment, the metal may be an alkali metal. For instance, the alkali metal may be lithium, sodium, potassium, or a combination thereof. In one particular embodiment, the alkali metal may be sodium, potassium, or a combination thereof. In another particular embodiment, the alkali metal may include sodium.

In another embodiment, the metal may be an alkaline earth metal. For instance, the alkaline earth metal may be beryllium, magnesium, calcium, strontium, barium, or a combination thereof. In one particular embodiment, the alkaline earth metal may be magnesium, calcium, or a combination thereof.

In a further embodiment, the metal may be a transition metal. For instance, the transition metal may be manganese, iron, cobalt, nickel, copper, zinc, titanium, chromium, platinum, gold, molybdenum, palladium, silver, tantalum, tungsten, etc., or a combination thereof.

In addition to alkali metals, alkaline earth metals, and transition metals, other metals may also be employed. For instance, the metal may be aluminum, indium, tin, bismuth, etc., or a combination thereof.

Furthermore, one mole of metal may be present. Alternatively, in one embodiment, two moles of metal may be present. As an example, the metal may simply be sodium. Alternatively, the metal may be disodium. In this regard, the number of moles of metal may depend on the charge of the anion. Thus, if the anion has a charge of −6, six moles of sodium may be required.

Notably, the phosphorus containing compound may be sodium monofluorophosphate. The salt includes when the components are present as ions of such compound or disassociated. For instance, the gypsum panel may comprise sodium and monofluorophosphate, which may not be complexed but instead may be uncomplexed or disassociated. Additionally, when disassociated, the gypsum panel may include one of the ions or both of the ions. Using the example of sodium monofluorophosphate, the gypsum panel may include sodium, monofluorophosphate, or both sodium and monofluorophosphate. In one embodiment, the phosphate component, such as the halofluorophosphate (e.g., monofluorophosphate), may complex with another cation or metal.

The phosphorus containing compound may be present in the gypsum slurry in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more based on the weight of the stucco. The phosphorus containing compound may be present in the gypsum slurry an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the stucco.

In one aspect, the phosphorus containing compound may be present in the nucleating composition in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more. In general, the phosphorus containing compound may be present in the nucleating composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less.

In some aspects, a nucleating composition may include a polyol (e.g., an ethoxylated polyol). In some aspects, a nucleating composition may include glycerin, which may be referred to as glycerin or glycerol.

In one aspect, a polyol (e.g., an ethoxylated polyol) and/or glycerin may be present in the nucleating composition in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more. Generally, a polyol (e.g., an ethoxylated polyol) and/or glycerin may be present in the nucleating composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less.

In general, the composition of the gypsum slurry is not necessarily limited and may be any generally known in the art. Generally, in one embodiment, the gypsum core is made from a gypsum slurry including at least stucco and water.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. Notably, a nucleating composition may include one or more foaming agents (e.g., an alkyl sulfate, an alkyl ether sulfate). In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry, gypsum core, and/or nucleating composition may include a dispersant, such as a carboxylate or a sulfonate. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry, the gypsum core, and/or a nucleating composition may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate, and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glycerol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In one embodiment, the surfactant may include a cationic surfactant. For instance, the surfactant may include a cationic surfactant such as water-soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

As indicated above, the additives of the gypsum slurry, gypsum core, and/or nucleating composition may include a starch. The starch may be one generally utilized in the art. Such starch may be combined with the stucco and water. In this regard, such starch may be present in the gypsum slurry as well as the resulting gypsum core and gypsum panel. In one aspect, one or more components of a gypsum panel may be free of starch. For instance, the gypsum core and/or gypsum slurry may be free of starch. In one aspect, a gypsum panel formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components (e.g., stucco, water) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a crystalline matrix of calcium sulfate dihydrate. In this respect, the stucco may convert into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present invention.

In one embodiment, the gypsum core may include a first gypsum core layer and a second gypsum core layer. The first gypsum core layer may be between the first facing material (e.g., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (e.g., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

The gypsum panel disclosed herein may have many applications. For instance, the gypsum panel may be used as a standalone panel in construction for the preparation of walls, ceilings, floors, roofing, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 50 microns to about 1200 microns, such as about 50 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g, including all increments of 0.01 m²/g therebetween. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In general, the Z-tensile strength is indicative of the force required to remove the gypsum panel from an adhered surface and may also provide an indication of the bleed-through of gypsum through the facing material, such as the glass mat facing material. In this regard, the Z-tensile strength, as determined in accordance with ASTM C297 as disclosed herein, may be 30 lb_{f} or more, such as 35 lb_{f} or more, such as 40 lb_{f} or more, such as 45 lb_{f} or more, such as 50 lb_{f} or more, such as 55 lb_{f} or more, such as 60 lb_{f} or more, such as 65 lb_{f} or more, such as 70 lb_{f} or more, such as 75 lb_{f} or more, such as 80 lb_{f} or more, such as 85 lb_{f} or more. The Z-tensile strength may be 150 lb_{f} or less, such as 140 lb_{f} or less, such as 130 lb_{f} or less, such as 120 lb_{f} or less, such as 110 lb_{f} or less, such as 100 lb_{f} or less, such as 90 lb_{f} or less, such as 85 lb_{f} or less, such as 80 lb_{f} or less, such as 75 lb_{f} or less, such as 70 lb_{f} or less, such as 65 lb_{f} or less, such as 60 lb_{f} or less.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lbᵣ or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

### Test Methods

Humidified Bond: A humidified bond analysis is performed utilizing 12″ by 12″ specimens of the gypsum panel. The specimens are placed on edge in a humidity chamber at 90° F. and 90% humidity with faces 2+/−¼ inches apart. As reported below, the exposure was for either 2 hours or 20 hours. The specimens should have a moisture meter reading of 50+ upon completion of the humidification. Immediately, the specimens were analyzed to determine the bond. First, score lines should be scribed across the full width of the sample at 4″ from one edge on the face and 4″ in from the opposite edge on the back wherein the score lines are parallel to one another and perpendicular to the direction of machine travel. Next, firmly hold the specimen on a bench top and while face up, break the core along a score line and leave the paper intact on the side to be evaluated. Holding each portion of the specimen in separate hands and having the exposed broken core in a line of vision, exert a pulling force on one half of the specimen while holding the other half in a steady position in order to peel or tear the paper away from the core. Continue the pulling force until the paper peels away from the core to the maximum extent possible. Repeat this pulling action for the companion portion of the specimen. Then, repeat both steps for the back of the specimen. Next, determine the bond failure area where the facing material is removed from the gypsum core, with 100% indicative of no paper to gypsum core bond and 0% indicative of no paper to core failure (i.e., full paper bond to the core).

### Example 1

Gypsum panels were formed in accordance with the present disclosure. For each gypsum panel sample, a mixture comprising ball-milled gypsum and water was sprayed onto the surface of the first facing material adjacent the gypsum slurry. The mixture contained 90% water and 10% ball-milled gypsum. Next, a gypsum slurry was contacted with the facing material. The first facing material and the second facing material of all samples were both paper facing materials. Notably, the gypsum slurry contained no starch. Then, a second facing material was provided on the gypsum slurry. Next, each respective gypsum panel was tested for humidified bond. The bottom ply of the facing material of Table 1 had a cobb value of 139 g/m². The bottom ply of the facing material of Table 2 had a cobb value of 68 g/m². The bottom ply of the facing material of Table 3 had a cobb value of 67 g/m². The bottom ply of the facing material of Table 4 had a cobb value of 64 g/m². The bottom ply of the facing material of Table 5 had a cobb value of 57 g/m². The bottom ply of the facing material of Table 6 had a cobb value of 44 g/m².

TABLE 1

| Sample | Ball-milled Gypsum | Humidified Bond |
|---|---|---|
| Number | [lbs/MSF] | [% Failure] |
| 1 | 0.00 | 100% |
| 2 | 0.00 | 100% |
| 3 | 0.28 | 10% |
| 4 | 0.31 | 25% |
| 5 | 0.43 | 0% |
| 6 | 0.54 | 10% |
| 7 | 0.59 | 4% |
| 8 | 0.61 | 0% |
| 9 | 1.08 | 50% |
| 10 | 1.57 | 100% |

TABLE 2

| Sample | Ball-milled Gypsum | Humidified Bond |
|---|---|---|
| Number | [lbs/MSF] | [% Failure] |
| 11 | 0.00 | 100% |
| 12 | 0.32 | 64% |
| 13 | 0.60 | 22% |
| 14 | 0.65 | 80% |
| 15 | 1.11 | 50% |
| 16 | 1.90 | 100% |

TABLE 3

| Sample | Ball-milled Gypsum | Humidified Bond |
|---|---|---|
| Number | [lbs/MSF] | [% Failure] |
| 17 | 0.00 | 100% |
| 18 | 0.29 | 25% |
| 19 | 1.20 | 68% |
| 20 | 1.64 | 100% |

TABLE 4

| Sample | Ball-milled Gypsum | Humidified Bond |
|---|---|---|
| Number | [lbs/MSF] | [% Failure] |
| 21 | 0.00 | 100% |
| 22 | 0.33 | 12% |
| 23 | 0.63 | 2% |
| 24 | 1.16 | 80% |

TABLE 5

| Sample | Ball-milled Gypsum | Humidified Bond |
|---|---|---|
| Number | [lbs/MSF] | [% Failure] |
| 25 | 0.00 | 100% |
| 26 | 0.30 | 4% |
| 27 | 0.60 | 2% |

TABLE 6

| Sample | Ball-milled Gypsum | Humidified Bond |
|---|---|---|
| Number | [lbs/MSF] | [% Failure] |
| 28 | 0.00 | 100% |
| 29 | 0.30 | 30% |
| 30 | 0.62 | 16% |
| 31 | 1.58 | 75% |

### Example 2

Gypsum panels were formed in accordance with the present disclosure. The first facing material and the second facing material of all samples were both paper facing materials. For the gypsum panel control sample, no mixture was applied to either facing material. For gypsum panel samples 1 and 2, a first facing material was provided. Next, a gypsum slurry was contacted with the first facing material. Notably, the gypsum slurry contained no starch. Then, a mixture comprising ball-milled gypsum and water was sprayed onto the surface of the second facing material that will be adjacent to the gypsum slurry. The mixture contained 90% water and 10% ball-milled gypsum. Next, the second facing material was provided on the gypsum slurry. For gypsum panel samples 3 and 4, a first facing material was provided. Next, a gypsum slurry was contacted with the first facing material. Notably, the gypsum slurry contained no starch. Then, a mixture comprising ball-milled gypsum and water was sprayed onto the surface of the second facing material that will be adjacent to the gypsum slurry. The mixture contained 90% water and 10% surfactant. The surfactant comprised a majority alkyl sulfate and a minority alkyl ether sulfate. Next, the second facing material was provided on the gypsum slurry. Notably, the gypsum slurry contained no starch. The nail pull strength for all samples was determined in accordance with ASTM C1396-17.

TABLE 7

| | Ball-milled | Alkyl Sulfate | Nail Pull |
|---|---|---|---|
| Sample | Gypsum | Surfactant | Strength |
| Number | [lbs/MSF] | [lbs/MSF] | [lbf] |
| Control | 0.00 | 0.00 | 70.4 |
| 1 | 0.30 | 0.00 | 73.5 |
| 2 | 0.30 | 0.00 | 75.5 |
| 3 | 0.00 | 0.12 | 79.7 |
| 4 | 0.00 | 0.12 | 81.7 |

### Example 3

Gypsum panels were formed in accordance with the present disclosure. The first facing material and the second facing material of all samples were both glass mat facing materials. For the gypsum panel control samples, no mixture was applied to either facing material. For gypsum panel samples 1-3, a first facing material was provided. Next, a gypsum slurry was contacted with the first facing material. Notably, the gypsum slurry contained no starch. Then, a mixture comprising ball-milled gypsum and water was sprayed onto the surface of the second facing material that will be adjacent to the gypsum slurry. The mixture contained 94.6% water and 5.4% ball-milled gypsum. Next, the second facing material was provided on the gypsum slurry. For gypsum panel samples 4-6, a first facing material was provided. Next, a gypsum slurry was contacted with the first facing material. Notably, the gypsum slurry contained no starch. Then, a mixture comprising ball-milled gypsum and water was sprayed onto the surface of the second facing material that will be adjacent to the gypsum slurry. The mixture contained 92.1% water and 7.9% ball-milled gypsum. Next, the second facing material was provided on the gypsum slurry. For gypsum panel samples 7-9, a first facing material was provided. Next, a gypsum slurry was contacted with the first facing material. Notably, the gypsum slurry contained no starch. Then, a mixture comprising ball-milled gypsum and water was sprayed onto the surface of the second facing material that will be adjacent to the gypsum slurry. The mixture contained 90.9% water and 9.1% ball-milled gypsum. Next, the second facing material was provided on the gypsum slurry. For gypsum panel samples 10-12, a first facing material was provided. Next, a gypsum slurry was contacted with the first facing material. Notably, the gypsum slurry contained no starch. Then, a mixture comprising ball-milled gypsum and water was sprayed onto the surface of the second facing material that will be adjacent to the gypsum slurry. The mixture contained 90.9% water and 9.1% ball-milled gypsum. Next, the second facing material was provided on the gypsum slurry. The Z-tensile strength for all samples was determined in accordance with ASTM C297.

TABLE 8

| | | Z-Tensile Strength |
|---|---|---|
| | Ball-milled | (Second Facing |
| Sample | Gypsum | Material) |
| Number | [lbs/MSF] | [lbf] |
| Control | 0.00 | 59.170 |
| Control | 0.00 | 55.652 |
| Control | 0.00 | 54.676 |
| 1 | 0.20 | 68.066 |
| 2 | 0.20 | 64.042 |
| 3 | 0.20 | 66.762 |
| 4 | 0.30 | 68.452 |
| 5 | 0.30 | 65.114 |
| 6 | 0.30 | 61.378 |
| 7 | 0.40 | 73.374 |
| 8 | 0.40 | 61.426 |
| 9 | 0.40 | 63.318 |
| 10 | 0.50 | 65.910 |
| 11 | 0.50 | 63.816 |
| 12 | 0.50 | 66.460 |

### Example 4

Gypsum panels were formed in accordance with the present disclosure. The first facing material and the second facing material of all samples were both glass mat facing materials. For the gypsum panel control sample, no mixture was applied to either facing material. For gypsum panel sample 1, a first facing material was provided. Next, a gypsum slurry was contacted with the first facing material. Notably, the gypsum slurry contained no starch. Then, a mixture comprising only water was sprayed onto the surface of the second facing material that will be adjacent to the gypsum slurry. Next, the second facing material was provided on the gypsum slurry. For gypsum panel sample 2, a first facing material was provided. Next, a gypsum slurry was contacted with the first facing material. Notably, the gypsum slurry contained no starch. Then, a mixture comprising ball-milled gypsum and water was sprayed onto the surface of the second facing material that will be adjacent to the gypsum slurry. The mixture contained about 90% water and about 10% ball-milled gypsum. Next, the second facing material was provided on the gypsum slurry. The Z-tensile strength for all samples was determined in accordance with ASTM C297.

TABLE 9

| | | Z-Tensile Strength |
|---|---|---|
| | Ball-milled | (Second Facing |
| Sample | Gypsum | Material) |
| Number | [lbs/MSF] | [lbf] |
| Control | 0.00 | 70 |
| 1 | 0.00 | 75 |
| 2 | 0.30 | 81 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A method for making a gypsum panel comprising:
providing a first facing material;
depositing a gypsum slurry comprising stucco and water onto the first facing material;
providing a second facing material on the gypsum slurry; and
allowing the stucco to convert to calcium sulfate dihydrate;
wherein the method further comprises providing a nucleating composition comprising a nucleating agent on the first facing material before depositing the gypsum slurry onto the first facing material, on the gypsum slurry before providing the second facing material on the gypsum slurry, on the second facing material before providing the second facing material on the gypsum slurry, or a combination thereof.

2. The method of claim 1, wherein the nucleating composition comprises the nucleating agent in an amount of about 50 wt. % or more.

3. The method of claim 1, wherein the nucleating agent is milled.

4. The method of claim 1, wherein the nucleating agent has an average particle size from about 0.1 microns to about 200 microns.

5. The method of claim 1, wherein the nucleating agent is gypsum.

6. The method of claim 1, wherein the nucleating composition comprises a liquid in an amount of about 50 wt. % or more.

7. The method of claim 1, wherein the nucleating composition comprises a grinding agent.

8. The method of claim 7, wherein the grinding agent is dextrose, a starch, a lignosulfonate, a naphthalene sulfonate, a polycarboxylate ester, boric acid, or a combination thereof.

9. The method of claim 1, wherein the nucleating composition comprises a surfactant, a polyol, a dispersant, a phosphorus containing compound, or a combination thereof.

10. The method of claim 1, wherein the gypsum slurry comprises a surfactant, a polyol, a dispersant, a phosphorus containing compound, or a combination thereof.

11. The method of claim 1, wherein the first facing material, the second facing material, or both comprise one or more plies, wherein the nucleating composition penetrates at least a portion of a thickness of the one or more plies of the first facing material, the second facing material, or both.

12. The method of claim 11, wherein at least one ply of the first facing material, the second facing material, or both has a cobb from about 30 g/m² to about 150 g/m².

13. The method of claim 1, wherein the nucleating composition penetrates at least a portion of a thickness of the first facing material, the second facing material, or both.

14. The method of claim 1, wherein the nucleating composition is present in the gypsum panel in an amount from about 0.01 lbs/MSF to about 5 lbs/MSF.

15. The method of claim 1, wherein the method comprises providing the nucleating composition comprising the nucleating agent on the first facing material before depositing the gypsum slurry onto the first facing material.

16. The method of claim 1, wherein the method comprises providing the nucleating composition comprising the nucleating agent on the second facing material before providing the second facing material on the gypsum slurry.

17. The method of claim 1, wherein the nucleating composition comprises a foaming agent.

18. A gypsum panel comprising:
a gypsum core, the gypsum core comprising gypsum; and
a first facing material and a second facing material sandwiching the gypsum core, wherein a nucleating composition is applied to at least a portion of a surface of the first facing material, the second facing material, or both that is adjacent to the gypsum core, the nucleating composition penetrating at least a portion of a thickness of the first facing material, the second facing material, or both.

19. The gypsum panel of claim 18, wherein the nucleating composition comprises a nucleating agent, wherein the nucleating agent is milled.

20. The gypsum panel of claim 18, wherein the first facing material, the second facing material, or both comprise one or more plies, wherein the nucleating composition penetrates at least a portion of a thickness of the one or more plies of the first facing material, the second facing material, or both.

21. The gypsum panel of claim 20, wherein at least one ply of the first facing material, the second facing material, or both has a cobb of about 30 g/m² or more.

22. The gypsum panel of claim 18, wherein the nucleating composition is present in the gypsum panel in an amount from about 0.01 lbs/MSF to about 5 lbs/MSF.
